(19) United States
(12) Patent Application Publication
(10) Pub. No.: US 2024/0237677 A1
(43) Pub. Date: Jul. 18, 2024

(54) ANIMAL FEED COMPOSITIONS

(71) Applicant: DSM IP ASSETS B.V., HEERLEN (NL)

(72) Inventors: Aaron COWIESON, Kaiseraugst (CH); Levy DO VALE TEIXEIRA, Kaiseraugst (CH); Jose-Otavio SORBARA, Kaiseraugst (CH); Carrie WALK, Kaiseraugst (CH)

(21) Appl. No.: 18/560,015

(22) PCT Filed: May 10, 2022
(86) PCT No.: PCT/EP2022/062532

§ 371 Date: Nov. 9, 2023

Related U.S. Application Data
(60) Provisional application No. 63/188,679, filed on May 14, 2021.

(51) Int. Cl. A23K 20/189; A23K 10/30; A23K 50/75

(52) U.S. Cl. CPC A23K 20/189; A23K 10/30; A23K 50/75

(57) ABSTRACT

The present invention relates to precision feed formulation. It further relates to a computer-implemented method of predicting the impact of corn quality in an animal feed on animal feed conversion ratio. It further relates to the use of a model for improving feed conversion ratio.

### BACKGROUND OF THE INVENTION

### Field of the Invention

The present invention relates to precision feed formulation.

It further relates to a computer-implemented method of predicting the impact of corn quality in an animal feed on animal feed efficiency.

It further relates to the use of a model for improving feed conversion ratio.

### Background of the Invention

Improving the growth performance of farm animals is needed in a world with a growing population eating more animal protein, and it is the object of the present invention to devise solutions which helps meet this challenge.

Cereal grains, such as corn, wheat and sorghum, contribute more than 65% of the composition of typical pig and poultry diets. These grains provide a source of energy, principally as starch and also some protein. Cereal grains also contain structural carbohydrates called non-starch polysaccharides (NSP) and lignin, which are not digested by endogenous enzymes in monogastric animals.

Nutrient digestibility of corn is influenced by many factors, such as genetic variety, growing conditions, harvest, drying and storage conditions, starch, protein or lipid structure and subsequently animal feed efficiency (measured as feed over gain or gain over feed) is impacted. Differences between corn samples can result in variability of apparent metabolizable energy (AME) of more than 400 kcal/kg (Cowieson, 2005) and 11 points difference in feed conversion ratio (FCR) of broilers (Williams et al., 2014).

Further, previous authors have reported beneficial (Kheravii et al., 2018) or detrimental (Agyekum and Nyachoti, 2017) impacts of dietary NSPs and lignin on animal growth performance or nutrient digestibility. The inconsistent effects are further confounded by variation in the nutrient and NSP content within the cereal which can also have negative effects on digestibility.

Profitability of livestock production systems can be increased through optimized nutritional management. It is therefore of great interest to the farmers to quantify corn quality and NSP and starch content and predict, preferably also improve, the effect on feed conversion ratio.

### SUMMARY OF THE INVENTION

The present invention solves this problem. We analyzed corn samples for factors such as total, soluble and insoluble NSP monomeric sugars (including arabinose, xylose, and glucose), in vitro starch digestibility (including rapidly digestible starch, slowly digestible starch, resistant starch, and total starch) and corn quality parameters including protein solubility (Promatest) and vitreousness, and surprisingly found that from the factos animal age [days], Corn protein solubility [eq mg Albumin], Corn vitreousness [%], Corn insoluble A:X ratio, Corn slowly digested starch [g/100 g] and Corn resistant starch [g/100 g] we can predict the FCR.

### Definitions

Animal: The term “animal” refers to any animal except humans. Examples of animals are monogastric animals, including but not limited to pigs or swine (including, but not limited to, piglets, growing pigs, and sows); poultry such as turkeys, ducks, quail, guinea fowl, geese, pigeons (including squabs) and chicken (including but not limited to broiler chickens (referred to herein as broilers), chicks, layer hens (referred to herein as layers)); pets such as cats and dogs; horses.

Animal age: The term “animal age” or “phase end days” refers to the age in days of the animals at the end of the feeding phase.

Animal feed: The term “animal feed” refers to any compound, preparation, or mixture suitable for, or intended for intake by an animal. Animal feed for a monogastric animal typically comprises concentrates as well as vitamins, minerals, enzymes, direct fed microbial, amino acids and/or other feed ingredients (such as in a premix) whereas animal feed for ruminants generally comprises forage (including roughage and silage) and may further comprise concentrates as well as vitamins, minerals, enzymes direct fed microbial, amino acid and/or other feed ingredients (such as in a premix).

Apparent metabolizable energy (AME): The term “Apparent metabolizable energy (AME)” is the gross energy of the feed consumed minus the gross energy contained in the feces, urine, and gaseous products of digestion.

Arabinoxylan-containing material: The term “Arabinoxylan-containing material” means any material containing arabinoxylan. Arabinoxylan is a hemicellulose found in both the primary and secondary cell walls of plants, including woods and cereal grains, consisting of copolymers of two pentose sugars, arabinose and xylose. The arabinoxylan chain contains a large number of 1,4-linked xylose units. Many xylose units are substituted with 2-, 3- or 2,3-substituted arabinose residues.

Body Weight Gain: The term “body weight gain” means an increase in live weight of an animal during a given period of time, e.g., the increase in weight from day 1 to day 21.

Carbohydrase: In the present context, a carbohydrase is an enzyme that catalyzes the breakdown of carbohydrates into simple sugars.

Examples of carbohydrases include, but are not limited to, glucanases, xylanase, pectinase, galactosidases, cellulose, mannanases, debranching enzymes and amylases.

Primary targets of carbohydrases are cellulose, arabinoxylans and mixed linked glucans from cereals and pectin polysaccharides and oligosaccharides from plant protein sources. For example, xylanase degrades the linear polysaccharide beta-1,4-xylan into xylose. It helps to breakdown cell wall and thus exposing starch and augmenting digestion.

Preferred carbohydrases according to the present invention are xylanses (as defined in more detail below) and α-galactosidases. α-galactosidase (α-GAL, also known as α-GAL A; E.C. 3.2.1.22) is a glycoside hydrolase enzyme that hydrolyses the terminal alpha-galactosyl moieties from glycolipids and glycoproteins.

Examples of carbohydrases useful in the present context are carbohydrases from Thermomyces lanuginosus or Trichderma reeseibeta-glucanases produced by fermentation of genetically modified micro-organisms as for example Aspergillus oryzae or Bacillus amyloliquefaciens.

The carbohydrase for use according to the invention is stable in the presence of protease. The protease stability may be determined by incubating 0.5 mg purified carbohydrase enzyme protein/ml in a buffer at a desired pH (e.g. pH 3, 4, or 5), for the desired time (e.g. 30, 45, 60, 90, or 120 minutes) in the presence of protease (e.g. pepsin, 70 mg/l), and then raising pH to the desired pH (e.g. pH 4, 5, 6, or 7) and measuring residual activity. The residual carbohydrase activity is preferably at least 20%, preferably at least 30, 40, 50, 60, 70, 80, or at least 90% relative to the control (a non-protease-treated sample).

For purposes of the present invention, preferred carbohydrases are the carbohydrases contained in the following commercial products: Ronozyme®VP, Ronozyme®A, Ronozyme®WX and Roxazyme® (DSM Nutritional Products AG).

In the use according to the invention the carbohydrases can be fed to the animal before, after, or simultaneously with the diet of the animal. The latter is preferred.

In a particular embodiment, the carbohydrases, in the form in which they are added to the feed, or when being included in a feed additive, are well-defined. Well-defined means, that the enyzme preparation is at least 50% pure on a protein-basis. In other particular embodiments the enzyme preparation is at least 60, 70, 80, 85, 88, 90, 92, 94, or at least 95% pure. Purity may be determined by any method known in the art, e.g. by SDS-PAGE, or by Size-exclusion chromatography (see Example 12 of WO 01/58275).

Concentrates: The term “concentrates” means feed with high protein and energy concentrations, such as fish meal, molasses, oligosaccharides, sorghum, seeds and grains (either whole or prepared by crushing, milling, etc. from e.g. corn, oats, rye, barley, wheat), oilseed press cake (e.g. from cottonseed, safflower, sunflower, soybean (such as soybean meal), rapeseed/canola, peanut or groundnut), palm kernel cake, yeast derived material and distillers grains (such as wet distillers grains (WDS) and dried distillers grains with solubles (DDGS).

Corn protein solubility: Solubility is one of the most important functional properties of proteins, but corn proteins exhibit limited solubility due to their high hydrophobicity and the presence of disulphide bonds (Esen, 1986). The term “Corn protein solubility” is also referred to as “salt soluble protein (SSP)” or “promatest” and Measured in [mg] using the procedure NF V03-741 recommended by AFNOR (2008) and presented as equivalent mg of albumine or mg proteins/100 ml. Brief methods are described by Janas et al., 2010

Dietary Fiber: The term dietary fiber generally refers to the coarse, indigestible plant matter, composed primarily of polysaccharides such as cellulose, that when eaten by humans stimulates intestinal peristalsis. For example, dietary fiber can include cell wall materials such as cellulose, hemicelluloses, lignin, and pectins, along with gums and mucilages that are not digested by the body. Dietary fiber includes polysaccharides, oligosaccharides, lignin, and associated plant substances. Soluble and insoluble fibres make up the two basic categories of dietary fibre. Cellulose, hemicellulose and lignin—are not soluble in water whereas pectins, gums and mucilages—become gummy in water. Sources of dietary fiber suitable for use in products and quantification in accordance with the disclosure include, but are not limited to, cereal brans, barley, psyllium, legumes, insulin, fructo-oligosaccharides, polydextrose, vegetable sources, fruit sources, grain sources, nuts, and flax seeds.

The amount of dietary fiber in a sample can be quantified by standard methods. These methods include, without being limited to, dissoluting the sample to produce a dietary fiber solution and then centrifuging the dietary fiber solution to produce a pellet and a supernatant liquid. After separating the supernatant liquid from the pellet, the pellet can be analyzed to determine a content of non-dietary fiber components in the pellet. The dietary fiber content in the pellet can be determined from the content of the non-dietary fiber components in the pellet. By using centrifugation to help isolate the dietary fiber in the sample, fiber loss may be minimized, leading to a more accurate determination of the content of dietary fiber in the sample

Feed Conversion Ratio: The term “feed conversion ratio” or “FCR” refers to the amount of feed fed to an animal to increase the weight of the animal by a specified amount. It is determined as the amount of feed eaten per bird over the amount of weight gained per bird. An improved feed conversion ratio means a lower feed conversion ratio. By “lower feed conversion ratio” or “improved feed conversion ratio” it is meant that the use of a feed additive composition in feed results in a lower amount of feed being required to be fed to an animal to increase the weight of the animal by a specified amount compared to the amount of feed required to increase the weight of the animal by the same amount when the feed does not comprise said feed additive composition. A lower FCR indicates less feed needed per kg, g or lb of gain.

To be able to compare different groups, flocks, houses or diets, assume all animals are of same weight, and the FCR is corrected for weight differences and becomes the body weight corrected feed conversion ratio (BWcFCR). For the purpose of the present invention, for birds, body weight correction is done by substracting 1 point in FCR per each 30 g of extra body weight, e.g. from 1.57 to 1.56.

Feed efficiency: The term “feed efficiency” means the amount of weight gain per unit of feed when the animal is fed ad-libitum or a specified amount of food during a period of time. By “increased feed efficiency” it is meant that the use of a feed additive composition according the present invention in feed results in an increased weight gain per unit of feed intake compared with an animal fed without said feed additive composition being present.

Fiber Fraction: The term “fiber fraction” or “dietary fiber fraction” for the purpose of this invention refers to the mass fraction (weight fraction), the ratio of the mass of a fiber component of a feed or food to the mass of another fiber component of the feed or food.

Specifically, this invention relates to the A/X ratio, or A/X fiber fraction, which is the ratio of the mass of arabinose (A) in a feed or food to the mass of xylose (X) in the feed or food.

A/X total feed ratios, the A/X ratio in the total diet, were calculated from the measured A/X corn ratio and the measured A/X soy bean meal ratio by using the ((percent corn in the diet×measured mass of arabinose in corn)+(percent soybean meal in diet×measured mass of arabinose in soybean meal))/((percent corn in diet×measured mass of xylose in corn)+(percent soybean meal in diet×measured mass of xylose in soybean meal)). A/X ratios in the total diet can range from 0.91 to 1.42.

For the purpose of illustrating the calculation of the A/X ratio in a total diet an example is given as follows: A broiler diet contains 57.43% corn and 37.6% soybean meal. The measured content of arabinose in corn was 1.72 g per 100 g corn and the measured content of xylose in corn was 2.41 g per 100 g corn. The measured content of arabinose in soybean meal was 2.42 g per 100 g soybean meal and the measured content of xylose in soybean meal was 1.25 g per 100 g soybean meal. Therefore, the calculated arabinose to xylose ratio in the total diet is 1.02=((57.43/100)*1.72)+((37.6/100)*2.42)/((57.43/100)*2.41)+((37.6/100)*1.25).

A/X corn ratio: The term “A/X corn fiber fraction” or “A/X corn ratio” or “A/X ratio” for the purpose of this invention refers to the ratio of the mass of arabinoxylans in a sample of corn to the mass of xylose in the same sample of corn. A/X ratios in corn typically range from 0.61 to 0.97

Insoluble A/X ratio: The term “Insoluble A/X ratio” or “Corn insoluble A/X ratio” is determined as the water non-extractable arabinose over the water non-extractable xylose content in corn, indicative of the structural features of corn arabinoxylan.

Intercept: The term “intercept” is a mathematical term to describe the point where a line crosses the x-axis.

Near-Infrared Spectroscopy: As used herein, the term “near-infrared spectroscopy (NIRS or NIR)” refers to a spectroscopic method that uses the near-infrared region of the electromagnetic spectrum (from about 700 nm to 2500 nm).

Non-starch polysaccharide (NSP): The term “non-starch polysaccharide (NSP)” refers to those polysaccharides (complex carbohydrates), other than starches, found in foods. They are the major part of dietary fibre and can be measured more precisely than total dietary fibre; include cellulose, pectins, glucans, gums, mucilages, inulin, and chitin (and exclude lignin). NSP fractions, include soluble and insoluble NSPs and constituent sugars.

Nutrient Digestibility: The term “nutrient digestibility” means the fraction of a nutrient that disappears from the gastro-intestinal tract or a specified segment of the gastro-intestinal tract, e.g., the small intestine. Nutrient digestibility may be measured as the difference between what is administered to the subject and what. comes out in the faeces of the subject, or between what is administered to the subject and what remains in the digesta on a specified segment of the gastro intestinal tract, e.g., the ileum.

Nutrient digestibility as used herein may be measured by the difference between the intake of a nutrient and the excreted nutrient by means of the total collection of excreta during a period of time; or with the use of an inert marker that is not absorbed by the animal, and allows the researcher calculating the amount of nutrient that disappeared in the entire gastro-intestinal tract or a segment of the gastro-intestinal tract. Such an inert marker may be titanium dioxide, chromic oxide or acid insoluble ash. Digestibility may be expressed as a percentage of the nutrient in the feed, or as mass units of digestible nutrient per mass units of nutrient in the feed. Nutrient digestibility as used herein encompasses starch digestibility, fat digestibility, protein digestibility, and amino acid digestibility.

Energy digestibility as used herein means the gross energy of the feed consumed minus the gross energy of the faeces or the gross energy of the feed consumed minus the gross energy of the remaining digesta on a specified segment of the gastro-intestinal tract of the animal, e.g., the ileum. Metabolizable energy as used herein refers to apparent metabolizable energy and means the gross energy of the feed consumed minus the gross energy contained in the faeces, urine, and gaseous products of digestion. Energy digestibility and metabolizable energy may be measured as the difference between the intake of gross energy and the gross energy excreted in the faeces or the digesta present in specified segment of the gastro-intestinal tract using the same methods to measure the digestibility of nutrients, with appropriate corrections for nitrogen excretion to calculate metabolizable energy of feed.

Protease: A protease is defined herein as an enzyme that hydrolyses the peptide bonds that link amino acids in a polypeptide chain that form a protein.

The internationally recognized schemes for the classification and nomenclature of all enzymes from IUMB include proteases. The updated IUMB text for protease EC numbers can be found at the internet site: http://www.chem.qmw/ac.uk/iubmb/enzyme/EC3/4/11/. In this system enzymes are defined by the fact that they catalyze a single reaction. This has the important implication that several different proteins are all described as the same enzyme, and a protein that catalyses more than one reaction is treated as more than one enzyme.

The system categorises the proteases into endo- and exoproteases. Endoproteases are those enzymes that hydrolyze internal peptide bonds of proteins and exoproteases are those enzymes that hydrolyze peptide bonds adjacent to a terminal α-amino group (so-called “aminopeptidases”), or a peptide bond between the terminal carboxyl group and the penultimate amino acid (so-called “carboxypeptidases”). The endoproteases are divided into sub-subclasses on the basis of catalytic mechanism. There are sub-subclasses of serine endoproteases (EC 3.4.21), cysteine endoproteases (EC 3.4.22), aspartic endoproteases (EC 3.4.23), metalloendoproteases (EC 3.4.24) and threonine endoproteases (EC 3.4.25).

A suitable protease in a process according to the present disclosure may for instance belong to a group selected from aspartic endoproteases, metalloendoproteases, and serine endoprotease. Suitable aspartic endoproteases may for instance be aspergillopepsin I (EC 3.4.23.18) or aspergillopepsin II (EC 3.4.23.19). Suitable metalloendoproteases may for instance be bacillolysin (EC. 3.4.24.28). A suitable serine endoprotease may for instance be subtilisin (EC 3.4.21.62) Aspegillopepsin I and II are usually produced by a fungus belonging to the genus Aspergillus, for instance an A. niger. Bacillolysin and subtilisin may be produced by Bacillus sp.

A protease in a process according to the present disclosure may comprise one or more proteases. For instance, a protease may comprise a mixture of aspergillopepsin I and aspergillopepsin II, or any other suitable mixtures of proteases.

Rapidly digested starch: The term “Rapidly digested starch” refers to starch that is rapidly digested after 20 minutes and measured using an in vitro assay developed by Englyst et al. (1999).

Resistant starch: The term “Resistant starch” refers to starch that is resistant to digestion by endogenous or exogenous enzymes. Measured using an in vitro assay developed by Englyst et al., (1999) or calculated as the starch remaining after rapidly digested starch and slowly digested starch are subtracted from the total starch.

Salt-soluble protein: Solubility of proteins relates to surface hydrophobic (protein-protein) and hydrophilic (protein-solvent) interaction; in food case, such solvent is the water, and therefore the protein solubility is classified as a hydrophilic property. The term “Salt-soluble protein” or “protein solubility” provides an indication of the susceptibility of the protein and starch granules in corn to enzymatic attack. Protein solubility of corn can be influenced by moisture content at harvest and drying time and temperature (Odjo et al., 2012). Salt-soluble protein is measured using the procedure NF V03-741 recommended by AFNOR (2008) and presented as equivalent mg of albumine or mg proteins/100 ml. Brief methods are described by Janas et al., 2010

Slowly digested starch: The term “Slowly digested starch” refers to starch that is slowly digested after 120 minutes and measured using an in vitro assay developed by Englyst et al. (1999) which includes the measurement of total starch, rapidly digested starch and resistant starch.

Total starch: The term “total starch” refers to a natural vegetable polymer consisting of long linear unbranched chains of alpha-1,4-linked D-glucose units (amylose) and or long alpha-1,6-branched glucose units (amylopectin). The methods to evaluate total starch include the measurement of glucose released through the use of alpha-amylases and amyloglucosidases that are specifically active on the alpha(1-4) and alpha (1-6) linkages. Total starch can be measured by multiple methods, not limited to those described by Englyst et al. (1999), Hall (2015) or McCleary et al. (2018).

Vitreousness: The term “vitreousness” is also described as rendement brut en semoule [%] by the analytical lab (Germ Services, France), which is the method used to determine Corn vitreousness for the purpose of the present invention. It is an important factor to determine grain texture, usually determined by the ratio of vitreous to floury endosperm-based on appearance with the vitreous region appearing glass-like and translucent where as the floury endosperm is white, mealy and nontranslucent (Zhang and Xu, 2019). Another method to semi-quantitatively define the starch and protein matrix in corn is to determine the percent vitreousness. High vitreousness is linked to greater protein (prolamin) and starch encapsulation and reduced starch digestibility (in vitro), especially as vitreousness increased above 60% (Blasel et al., 2006).

Xylanase: In the present context, a xylanase is an enzyme that degrades the linear polysaccharide beta-1,4-xylan into xylose. It helps to breakdown cell wall and thus exposing starch and augmenting digestion.

Preferably, the term “xylanase” refers to a glucuronoarabinoxylan endo-1,4-beta-xylanase (E.C. 3.2.1.136) that catalyses the endohydrolysis of 1,4-beta-D-xylosyl links in some glucuronoarabinoxylans.

Commercially available GH10 and GH11 xylanases are often used to break down the xylose backbone of arabinoxylan. In animal feed this results in a degradation of the cereal cell wall with a subsequent improvement in nutrient release (starch and protein) encapsulated within the cells. Degradation of xylan also results in the formation of xylose oligomers that may be utilised for hind gut fermentation and therefore can help an animal to obtain more digestible energy. However, such xylanases are sensitive to side chain steric hindrance and whilst they are effective at degrading arabinoxylan from wheat, they are not very effective on the xylan found in the seeds of Poaceae species, such as corn or sorghum.

Xylose-containing material: The term “Xylose-containing material” means any material containing xylose. Xylose is a pentose sugar and the main building block for the hemicellulose xylan. Xyloce may be extracted from wood, sugar cane or coconuts. It also naturally occurs in small amounts in berries, spinach, broccoli, and pears and as part of the dietary fiber arabinoxylan. The arabinoxylan chain contains a large number of 1,4-linked xylose units. Many xylose units are substituted with 2-, 3- or 2,3-substituted arabinose residues.

### DETAILED DESCRIPTION OF THE INVENTION

It further relates to the use of a model for improving FCR.

### Computer-Implemented Method of Predicting the Impact of Corn Quality in an Animal Feed on Animal Feed Conversion Ratio

In one embodiment, the present invention relates to a computer-implemented method of predicting the impact of corn quality in an animal feed on animal feed conversion ratio.

This computer-implemented method, comprises the steps of
a) receiving data, said data comprising information about an animal(s) and the animal's feed,
b) providing a model which allows to predict the FCR from the data received in step (a),
c) using the data from step (a) and the model of step (b) to predict the FCR.

The animal may be a singe animal, but also a group of animals, such as a herd or flock or swarm or another group of animals and the data about the animal received in step (a) may be the age of an individual animal [days] or an average value of the ages of a group of animals.

The information about the animal's feed may be factors characterizing feed quality, preferably corn quality, preferably from the group of Corn protein solubility [mg], Corn vitreousness [%], Corn insoluble A:X ratio, Corn slowly digested starch [g/100 g] and Corn resistant starch [g/100 g].

In one specific embodiment, the phase end day [days] is in the range of 5 to 100, preferably 5 to 90, preferably 5 to 80, preferably 5 to 70, preferably 5 to 60, preferably 5 to 50, preferably 10 to 50.

In one specific embodiment, the predicted FCR is in the range of 1 to 2, preferably 1.1 to 2, preferably 1.1 to 1.9, preferably 1.1 to 1.8.

In one specific embodiment, the Corn protein Solubility [mg] is over 50, preferably in the range of 50 to 100, preferably 50 to 90, preferably 50 to 80, preferably 50 to 70.

In one specific embodiment, the Corn Vitreousness [%] is in the range of 30 to 100, preferably 40 to 100, preferably 50 to 100, preferably 50 to 90, preferably 50 to 80, preferably 50 to 70, preferably 55 to 70.

In one specific embodiment, the Corn insoluble A/X ratio is in the range of 0.5 to 1.0, preferably 0.6 to 1.0, preferably 0.6 to 0.9, preferably 0.65 to 0.9.

In one specific embodiment, the Corn slowly digested starch [g/100 g] is in the range of 10 to 60, preferably 15 to 60, preferably 20 to 60, preferably 20 to 55, preferably 20 to 50, preferably 20 to 45.

In one specific embodiment, the Corn resistant starch [g/100 g] is in the range of 0 to 30, preferably 0 to 25, preferably 1 to 20, preferably 2 to 20.

The information about the animal(s) and the animal's feed then may be used to build a model, such as an equation, which allows to predict the FCR or may be fed into an existing model predicting the FCR.

The data received in step (a) may be supplied by a laboratory. Alternatively, quantitative analysis of corn quality in animal feed, for example one or more of factors such as total and insoluble NSP monomeric sugars (including arabinose, xylose, and glucose), in vitro starch digestibility (including rapidly digestible starch, slowly digestible starch, resistant starch, and total starch) and corn quality parameters including protein solubility (Promatest) and vitreousness may be performed by standard methods, such as wet chemistry, HPLC, GLC or spectrophotometry, and enzyme assays.

Wet chemistry methods include the methods as used by Englyst et al. (Englyst H N, Quigley M E, Hudson G J (1994). Determination of dietary fiber as non-starch polysaccharides with gas-liquid chromatographic, high-performance liquid chromatographic or spectrophotometric measurement of constituent sugars. Analyst 119, 1497-1509.) to determine the non-starch polysaccharides (NSP) in the form of soluble, insoluble and total NSP fractions from feed or ingredient samples are separated. Briefly, 5 mL of sodium acetate buffer is added to the ground feed or ingredient sample followed by serial enzymatic treatment for starch removal. The sample is then centrifuged to collect the soluble NSP fraction. The remaining pellet is the insoluble NSP. Both portions are acid hydrolysed and the monosaccharides are determined using gas chromatography, high performance liquid chromatography or spectrophotometry.

Enzyme assays can be purchased as kits, for example from Megazyme.

Additionally, dietary fiber feactions may be calculated from other fractions or as a percent of NDF as in the paper as disclosed by Balckom et al. (Mourtzinis S, Arriaga F J, Bransby D, Balcom K S (2014). A simplified method for monomeric carbohydrateanalysis of corn stover biomass. GCB Bioenergy 6, 300-304.).

The quantitative analysis of of corn quality in animal feed by said wet chemistry methods is rather time and cost consuming. Near infrared measurements (NIR) of the respective animal feed is a more time and cost efficient alternative for determining corn quality in animal feed. However, near infrared spectroscopy does not give the results with the desired precision. Accordingly, neither quantitative analysis nor near infrared spectroscopy alone are suitable for a cost and time efficient determination of corn quality in the total amount of the animal feed.

According to the present invention this problem is solved in that the near infrared absorptions obtained for a sample of an animal feed ingredient are correlated with the corresponding values of the quantitative analysis of the same. The thus obtained correlation of the values of the quantitative analysis with the absorptions of the NIR measurement is preferably depicted or plotted as a calibration graph, which facilitates the matching of the absorptions of the NIR measurements of other sample with the corresponding exact values for the parameters based on the quantitative analysis.

Another object of the present invention is therefore a computer-implemented method of predicting the impact of corn quality in an animal feed on animal feed conversion ratio further comprising the steps of subjecting a sample of an animal feed to
i) near infrared (NIR) spectroscopy to obtain an NIR spectrum;
ii) matching the absorption intensities at the respective wavelengths or wavenumbers in the NIR spectrum obtained in i) with a calibration graph or equation
iii) a quantitative analysis of the at least one of Corn protein solubility [mg], Corn vitreousness [%], Corn insoluble A:X ratio, Corn slowly digested starch [g/100 g] and Corn resistant starch [g/100 g] in the sample.

The present invention further comprises the step of generating a calibration graph or equation as in ii) by additionally following the steps
A-i) subjecting a sample of an animal feed as in step a) to nearinfrared (NIR) spectroscopy;
A-ii) matching the absorption intensities at the respective wavelengths or wavenumbers in the NIR spectrum obtained in step A-i) with the corresponding parameters and their values determined by iii) of subjecting the sample to
   a1) a quantitative analysis of the at least one of Corn protein solubility [mg], Corn vitreousness [%], Corn insoluble A/X ratio, Corn slowly digested starch [g/100 g] and Corn resistant starch [g/100 g] in the sample;
   a2) a determination of the at least one of Corn protein solubility [mg], Corn vitreousness [%], Corn insoluble A:X ratio, Corn slowly digested starch [g/100 g] and Corn resistant starch [g/100 g] in the total amount of the animal feed; and
A-iii) plotting the matching of step A-ii) as a calibration graph and/or expressing the parameters determined in steps a1) and a2) in a calibration equation as a function of the absorption intensities at the respective wavelengths or wavenumbers matched in step A-iii).

Depending on the spectrometer used, the near-infrared (NIR) spectra can be recorded at wavelengths between 400 and 2,500 nm with any suitable infrared spectroscopes working either on the monochromator principle or on the Fourier transform principle. Preferably, the NIR spectra are recorded between 1,000 and 2,500 nm. Wavelengths are easily converted into the respective wavenumbers and therefore, the NIR spectra can of course also be recorded at the corresponding wavenumbers. Organic compounds rich in O—H bonds, C—H bonds and N—H bonds are suitable for the detection by means of near-infrared spectroscopy. However, a biological sample such as an animal feed contains a multitude of different organic compounds and thus represents a complex matrix. Notwithstanding every biological substance has a unique near-infrared spectrum, comparable to an individual finger print. Consequently, two biological substances having exactly the same spectrum can be assumed to have the same physical and chemical composition and thus to be identical. On the other hand, if two biological substances have different spectra, it can be assumed that they are different, either in terms of their physical or chemical characteristics or in both terms. Due to their individual and highly specific absorption bands the signals of organic compounds and their intensities in NIR spectra can be easily attributed and correlated to a specific organic compound and its concentration in a sample of known weight. Thus, the NIR spectroscopy allows a reliable prediction or assessment of for example the amount of dietary fiber in a sample. Since the same sample of a specific animal feed is subjected to the quantitative analysis in step a) and to the NIR spectroscopy in step A), it is also possible to attribute and correlate absorptions and their intensities in an NIR spectrum to parameters, such as the amount of arabinoxylans in the sample. Once, the absorption intensities at the respective wavelengths or wavenumbers have been successfully matched, i.e. attributed and correlated to the parameters of interest and their values, the NIR spectroscopy allows a reliable prediction or assessment of the dietary fiber in the animal feed. For this purpose a large number of NIR spectra, e.g. 100, 200, 300, 400, 500 or more, of an animal feed are recorded, and the absorption intensities at the respective wavelengths or wavenumbers are matched with the corresponding parameters and their values.

One embodiment of the present invention will be illustrated, but not limited, by the second example.

### Use of a Model for Improving FCR

The present invention is also directed to the use of a model for improving FCR. According to the present invention, the use of a model predicting FCR from data comprises information about the animal(s) and the animal's feed for improving FCR.

In the present invention, the FCR may be improved by at least 1%, such as by at least 0.5%, preferably 1%, preferably 1.5%, preferably 2%, preferably 2.5%, preferably 3%, preferably 3.5%, preferably 4%, preferably 4.5%, preferably 5%, preferably 6%, preferably 7%, preferably 8%.

The animal may be a singe animal, but also a group of animals, such as a herd or flock or swarm or another group of animals and the data about the animal received in step (a) may be the age of an individual animal [days] or an average value of the ages of a group of animals.

The information about the animal's feed may be factors characterizing feed quality, preferably corn quality, preferably from the group of Corn protein solubility [mg], Corn vitreousness [%], Corn insoluble A:X ratio, Corn slowly digested starch [g/100 g] and Corn resistant starch [g/100 g].

In one specific embodiment, the phase end day [days] is in the range of 5 to 100, preferably 5 to 90, preferably 5 to 80, preferably 5 to 70, preferably 5 to 60, preferably 5 to 50, preferably 10 to 50.

In one specific embodiment, the predicted FCR is in the range of 1 to 2, preferably 1.1 to 2, preferably 1.1 to 1.9, preferably 1.1 to 1.8.

In one specific embodiment, the Corn protein Solubility [mg] is over 50, preferably in the range of 50 to 100, preferably 50 to 90, preferably 50 to 80, preferably 50 to 70.

In one specific embodiment, the Corn Vitreousness [%] is in the range of 30 to 100, preferably to 100, preferably 50 to 100, preferably 50 to 90, preferably 50 to 80, preferably 50 to 70, preferably 55 to 70.

In one specific embodiment, the Corn insoluble A/X ratio is in the range of 0.5 to 1.0, preferably 0.6 to 1.0, preferably 0.6 to 0.9, preferably 0.65 to 0.9.

In one specific embodiment, the Corn slowly digested starch [g/100 g] is in the range of 10 to 60, preferably 15 to 60, preferably 20 to 60, preferably 20 to 55, preferably 20 to 50, preferably 20 to 45.

In one specific embodiment, the Corn resistant starch [g/100 g] is in the range of 0 to 30, preferably 0 to 25, preferably 1 to 20, preferably 2 to 20.

In the present invention, the improvements are compared to the same feed but excluding the adjustment to the feed to improve FCR.

In an embodiment, the adjustment is the addition to an exogenous enzyme, preferably a carbohydrase and/or a protease, preferably from the group of glucanases, xylanase, pectinase, galactosidases, cellulose, mannanases, debranching enzymes or amylases.

### EMBODIMENTS OF THE INVENTION

1. A computer-implemented method of predicting feed conversion ratio of an animal feed, comprising the steps of
a) receiving data, said data comprising information about the animal(s) and the animal's feed,
b) providing a model which allows to predict the feed conversion ratio from the data received in step (a),
c) using the data from step (a) and the model of step (b) to predict the feed conversion ratio.

2. The method according to claim 1, wherein the information about the animal(s) and the animal's feed are the age of the animal(s) [days], Corn protein solubility [mg], Corn vitreousness [%], Corn insoluble A:X ratio, Corn slowly digested starch [g/100 g] and Corn resistant starch [g/100 g].

3. The method according to claim 1 or 2, wherein the model provided in step (b) uses the variables age of the animal(s) [days], Corn protein solubility [mg], Corn vitreousness [%], Corn insoluble A:X ratio, Corn slowly digested starch [g/100 g] and Corn resistant starch [g/100 g].

4. The method according to any of claims 1 to 3, wherein the model provided in step (b) uses Equation 1 to predict feed conversion ratio.

5. The method according to any of claims 1 to 4, wherein at least one of Corn protein solubility [mg], Corn vitreousness [%], Corn insoluble A:X ratio, Corn slowly digested starch [g/100 g] and Corn resistant starch [g/100 g] is determined by NIR analysis of a feed sample.

6. The method according to claim 5, further comprising the steps of subjecting a sample of an animal feed to
i) near infrared (NIR) spectroscopy to obtain an NIR spectrum;
ii) matching the absorption intensities at the respective wavelengths or wavenumbers in the NIR spectrum obtained in i) with a calibration graph or equation
iii) a quantitative analysis of the at least one of Corn protein solubility [mg], Corn vitreousness [%], Corn insoluble A:X ratio, Corn slowly digested starch [g/100 g] and Corn resistant starch [g/100 g] in the sample.

7. The method according to any of claims 1 to 6, wherein the animal is a mono-gastric animal, e.g. pigs or swine (including, but not limited to, piglets, growing pigs, and sows); poultry (including but not limited to poultry, turkey, duck, quail, guinea fowl, goose, pigeon, squab, chicken, broiler, layer, pullet and chick); pet animals such as cats and dogs, fish (including but not limited to amberjack, arapaima, barb, bass, bluefish, bocachico, bream, bullhead, cachama, carp, catfish, catla, chanos, char, cichlid, cobia, cod, crappie, dorada, drum, eel, goby, goldfish, gourami, grouper, guapote, halibut, java, labeo, lai, loach, mackerel, milkfish, mojarra, mudfish, mullet, paco, pearlspot, pejerrey, perch, pike, pompano, roach, salmon, sampa, sauger, sea bass, seabream, shiner, sleeper, snakehead, snapper, snook, sole, spinefoot, sturgeon, sunfish, sweetfish, tench, terror, tilapia, trout, tuna, turbot, vendace, walleye and whitefish); and crustaceans (including but not limited to shrimps and prawns).

8. The method according to any of claims 1 to 7, wherein the phase end day [days] is in the range of 5 to 100, preferably 5 to 90, preferably 5 to 80, preferably 5 to 70, preferably 5 to 60, preferably 5 to 50, preferably 10 to 50.

9. The method according to any of claims 1 to 8, wherein the predicted feed conversion ratio is in the range of 1 to 2, preferably 1.1 to 2, preferably 1.1 to 1.9, preferably 1.1 to 1.8.

10. The method according to any of claims 1 to 9, wherein the Corn protein Solubility [mg] is over 50, preferably in the range of 50 to 100, preferably 50 to 90, preferably 50 to 80, preferably 50 to 70.

11. The method according to any of claims 1 to 10, wherein the Corn Vitreousness [%] is in the range of 30 to 100, preferably 40 to 100, preferably 50 to 100, preferably 50 to 90, preferably 50 to 80, preferably 50 to 70, preferably 55 to 70.

12. The method according to any of claims 1 to 11, wherein the Corn insoluble A/X ratio is in the range of 0.5 to 1.0, preferably 0.6 to 1.0, preferably 0.6 to 0.9, preferably 0.65 to 0.9.

13. The method according to any of claims 1 to 12, wherein the Corn slowly digested starch [g/100 g] is in the range of 10 to 60, preferably 15 to 60, preferably 20 to 60, preferably 20 to 55, preferably 20 to 50, preferably 20 to 45.

14. The method according to any of claims 1 to 13, wherein the Corn resistant starch [g/100 g] is in the range of 0 to 30, preferably 0 to 25, preferably 1 to 20, preferably 2 to 20.

15. Use of a model predicting feed conversion ratio from data comprising information about the animal(s) and the animal's feed for improving feed conversion ratio.

16. The use according to claim 15, comprising the step of making an adjustment to the feed to improve feed conversion ratio.

17. The use according to claim 16, wherein the adjustment is the addition to an exogenous enzyme to the feed.

18. The use according to claim 17, wherein the exogenous enzyme is a carbohydrase and/or a protease.

19. The use according to claim 18, wherein the carbohydrase is from the group of glucanases, xylanase, pectinase, galactosidases, cellulose, mannanases, debranching enzymes or amylases.

20. The use according to any of claims 15 to 19, wherein the feed conversion ratio is improved by 0.5%, preferably 1%, preferably 1.5%, preferably 2%, preferably 2.5%, preferably 3%, preferably 3.5%, preferably 4%, preferably 4.5%, preferably 5%, preferably 6%, preferably 7%, preferably 8%.

21. The use according to any of claims 15 to 20, wherein the information about the animal(s) and the animal's feed are the age of the animal(s) [days], Corn protein solubility [mg], Corn vitreousness [%], Corn insoluble A:X ratio, Corn slowly digested starch [g/100 g] and Corn resistant starch [g/100 g].

22. The use according to any of claims 15 to 21, wherein the animal is a mono-gastric animal, e.g. pigs or swine (including, but not limited to, piglets, growing pigs, and sows); poultry (including but not limited to poultry, turkey, duck, quail, guinea fowl, goose, pigeon, squab, chicken, broiler, layer, pullet and chick); pet animals such as cats and dogs, fish (including but not limited to amberjack, arapaima, barb, bass, bluefish, bocachico, bream, bullhead, cachama, carp, catfish, catla, chanos, char, cichlid, cobia, cod, crappie, dorada, drum, eel, goby, goldfish, gourami, grouper, guapote, halibut, java, labeo, lai, loach, mackerel, milkfish, mojarra, mudfish, mullet, paco, pearlspot, pejerrey, perch, pike, pompano, roach, salmon, sampa, sauger, sea bass, seabream, shiner, sleeper, snakehead, snapper, snook, sole, spinefoot, sturgeon, sunfish, sweetfish, tench, terror, tilapia, trout, tuna, turbot, vendace, walleye and whitefish); and crustaceans (including but not limited to shrimps and prawns).

The present invention will be further illustrated by the following examples.

### EXAMPLES

### Example 1

The study evaluated the impact of corn quality, corn non-starch polysaccharide (NSP) sugars, and in vitro starch digestibility of corn on broiler feed conversion ratio.

A meta-analysis was carried out to quantify the impact of corn quality, corn non-starch polysaccharide (NSP) sugars, and in vitro starch digestibility of corn on broiler feed conversion ratio. The analysis was carried out on the data from 23 broiler trials conducted in North (58%) and South (42%) America between 2017 and 2019. In all trials, broilers were fed corn and soybean meal-based diets, formulated to meet or exceed nutrient requirements, including AME. This corresponded to a total of 66 datapoints. The concentration of corn in the experimental diets ranged from 48.9 to 66.9% and the AME content ranged from 3,020 to 3,271 kcal/kg, depending on the age of the bird and feeding phase. All trials started on day of hatch and concluded between day 33 or 49, with the majority (73%) of the trials ending on day 42. Corn samples from all of the trials and feeding phases were collected. The corn samples were analyzed for total and insoluble NSP monomeric sugars (including arabinose, xylose, and glucose), in vitro starch digestibility (including rapidly digestible starch, slowly digestible starch, resistant starch, and total starch) and corn quality parameters including protein solubility (Promatest) and vitreousness. Corn quality, starch digestibility, and NSP data, as well as broiler FCR were analyzed using step-wise regressions in the fit model platform of JMP Pro v. 15.1. A portion of the data (70%) was used to build the model and 30% of the data was used to validate the model. Correlations between factors were evaluated and removed or incorporated into the model as interaction terms. Non-significant model effects were removed, unless part of a significant interaction. The final model was selected based on R² (0.84), cross validation R² (0.68), and significance of the factors (P<0.05). The term ‘end phase day’ was included in the model to account for the natural increase in FCR as the birds age (P<0.0001). Corn quality parameters predicted to significantly negatively influence broiler FCR included: increasing vitreousness (P=0.01), greater insoluble A:X ratio (P=0.0001) and a higher content of slowly digestible starch (P=0.02), whereas increasing protein solubility (P=0.006) from 27 to 50 eq. mg albumin was predicted to improve broiler FCR, but only if resistant starch was less than 13 g/100 g (interaction, P=0.03). Inputting the results from a naïve sample of corns harvested in 2020, broiler FCR was predicted to differ by approximately 12 points (1.57 vs. 1.45). These results highlight the significant impact corn quality parameters, such as vitreousness, insoluble A:X ratio and slowly digestible starch have on broiler FCR and relationships between protein solubility and resistant starch.

The following tables show the predicted effect of changes in quality of corn, protein solubility & resistant starch and insoluble A:X ratio on FCR.

TABLE 1
The model estimates FCR will be low
in birds fed a high quality corn

| Terms | Mean | P-value |
|---|---|---|
| Intercept | 1 | 0.0294 |
| Bird age, days | 42 | <.0001 |
| Corn protein solubility, mg | 49 | 0.0404 |
| Corn vitreousness, % | 65 | 0.0195 |
| Corn insoluble A:X ratio | 0.68 | <.0001 |
| Corn slowly digested starch [g/100 g] | 29 | 0.0228 |
| Corn resistant starch [g/100 g] | 9.8 | 0.1201 |
| Vitreousness × Corn slowly digested starch | 1882 | 0.0379 |
| Protein solubility × Corn resistant starch | 480 | 0.0757 |
| Predicted FCR | 1.484 | |

TABLE 2
The model estimates FCR will be high
in birds fed a poor quality corn

| Terms | Mean | P-value |
|---|---|---|
| Intercept | 1 | 0.0294 |
| Bird age, days | 42 | <.0001 |
| Corn protein solubility | 21 | 0.0404 |
| Corn vitreousness, % | 66 | 0.0195 |
| Corn insoluble A:X ratio | 0.71 | <.0001 |
| Corn slowly digested starch [g/100 g] | 31 | 0.0228 |
| Corn resistant starch [g/100 g] | 12.8 | 0.1201 |
| Vitreousness × Corn slowly digested starch | 2049 | 0.0379 |
| Protein solubility × Corn resistant starch | 269 | 0.0757 |
| Predicted FCR | 1.570 | |

TABLE 3
Increasing protein solubility and reducing
resistant starch improves FCR

| Terms | Mean | P-value |
|---|---|---|
| Intercept | 1 | 0.0294 |
| Bird age, days | 42 | <.0001 |
| Corn protein solubility | 50 | 0.0404 |
| Corn vitreousness, % | 66 | 0.0195 |
| Corn insoluble A:X ratio | 0.71 | <.0001 |
| Corn slowly digested starch [g/100 g] | 31 | 0.0228 |
| Corn resistant starch [g/100 g] | 5.5 | 0.1201 |
| Vitreousness × Corn slowly digested starch | 2049 | 0.0379 |
| Protein solubility × Corn resistant starch | 275 | 0.0757 |
| Predicted FCR | 1.514 | |

TABLE 4
Increasing the insoluble A:X ratio increases FCR

| Terms | Mean | P-value |
|---|---|---|
| Intercept | 1 | 0.0294 |
| Bird age, days | 42 | <.0001 |
| Corn protein solubility | 49 | 0.0404 |
| Corn vitreousness, % | 65 | 0.0195 |
| Corn insoluble A:X ratio | 0.78 | <.0001 |
| Corn slowly digested starch [g/100 g] | 29 | 0.0228 |
| Corn resistant starch [g/100 g] | 9.8 | 0.1201 |
| Vitreousness × Corn slowly digested starch | 1882 | 0.0379 |
| Protein solubility × Corn resistant starch | 480 | 0.0757 |
| Predicted FCR | 1.605 | |

Terms that were not significant in the statistical model included:

Corn total, insoluble or soluble non-starch polysaccharides measured using methods of Englyst et al., 1994

Corn total starch measured by Englyst et al. (1999)

Corn monosaccharide sugars such as glucose or mannose, measured using methods of Englyst et al. 1994

The relationship between the FCR and the age of the animal(s) [days], Corn protein solubility [mg], Corn vitreousness [%], Corn insoluble A:X ratio, Corn slowly digested starch [g/100 g] and Corn resistant starch [g/100 g] can be described by the following equation.

Equation 1: Equation to predict FCR

$$FCR = - 5.433142554 + 0.0 \; 118111546 \times p hase end day [ days ] - 0.010015378 \times Corn Protein Solubility [ mg ] + 0.0873459845 \times Vitreousness Corn [ \% ] + 1.2153270409 \times Corn insoluble A / X ratio + 0.1590812717 \times Corn slowly digested starch [ g / 100 g ] - 0.031427316 Corn resistant starch [ g / 100 g ] - 0.002281607 Vitreousness Corn [ \% ] \times Corn slowly digested starch [ g / 100 g ] + 0.0008439099 \times Corn Protein Solubility [ mg ] \times Corn resistant starch [ g / 100 g ]$$

1. A computer-implemented method of predicting feed conversion ratio of an animal feed, comprising the steps of
a) receiving data, said data comprising information about the animal(s) and the animal's feed,
b) providing a model which allows to predict the feed conversion ratio from the data received in step (a),
c) using the data from step (a) and the model of step (b) to predict the feed conversion ratio.

2. The method according to claim 1, wherein the information about the animal(s) and the animal's feed are the age of the animal(s) [days], Corn protein solubility [mg], Corn vitreousness [%], Corn insoluble A:X ratio, Corn slowly digested starch [g/100 g] and Corn resistant starch [g/100 g].

3. The method according to claim 1, wherein the model provided in step (b) uses the variables age of the animal(s) [days], Corn protein solubility [mg], Corn vitreousness [%], Corn insoluble A:X ratio, Corn slowly digested starch [g/100 g] and Corn resistant starch [g/100 g].

4. The method according to claim 1, wherein the model provided in step (b) uses Equation 1 to predict feed conversion ratio.

5. The method according to claim 1, wherein at least one of Corn protein solubility [mg], Corn vitreousness [%], Corn insoluble A:X ratio, Corn slowly digested starch [g/100 g] and Corn resistant starch [g/100 g] is determined by NIR analysis of a feed sample.

6. The method according to claim 5, further comprising the steps of subjecting a sample of an animal feed to
i) near infrared (NIR) spectroscopy to obtain an NIR spectrum;
ii) matching the absorption intensities at the respective wavelengths or wavenumbers in the NIR spectrum obtained in i) with a calibration graph or equation
iii) a quantitative analysis of the at least one of Corn protein solubility [mg], Corn vitreousness [%], Corn insoluble A:X ratio, Corn slowly digested starch [g/100 g] and Corn resistant starch [g/100 g] in the sample.

7. The method according to claim 1, wherein the animal is a mono-gastric animal, e.g. pigs or swine (including, but not limited to, piglets, growing pigs, and sows); poultry (including but not limited to poultry, turkey, duck, quail, guinea fowl, goose, pigeon, squab, chicken, broiler, layer, pullet and chick); pet animals such as cats and dogs, fish (including but not limited to amberjack, arapaima, barb, bass, bluefish, bocachico, bream, bullhead, cachama, carp, catfish, catla, chanos, char, cichlid, cobia, cod, crappie, dorada, drum, eel, goby, goldfish, gourami, grouper, guapote, halibut, java, labeo, lai, loach, mackerel, milkfish, mojarra, mudfish, mullet, paco, pearlspot, pejerrey, perch, pike, pompano, roach, salmon, sampa, sauger, sea bass, seabream, shiner, sleeper, snakehead, snapper, snook, sole, spinefoot, sturgeon, sunfish, sweetfish, tench, terror, tilapia, trout, tuna, turbot, vendace, walleye and whitefish); and crustaceans (including but not limited to shrimps and prawns).

8. Use of a model predicting feed conversion ratio from data comprising information about the animal(s) and the animal's feed for improving feed conversion ratio.

9. The use according to claim 8, comprising the step of making an adjustment to the feed to improve feed conversion ratio.

10. The use according to claim 9, wherein the adjustment is the addition to an exogenous enzyme to the feed.

11. The use according to claim 10, wherein the exogenous enzyme is a carbohydrase and/or a protease.

12. The use according to claim 11, wherein the carbohydrase is from the group of glucanases, xylanase, pectinase, galactosidases, cellulose, mannanases, debranching enzymes or amylases.

13. The use according to claim 8, wherein the feed conversion ratio is improved by 0.5%, preferably 1%, preferably 1.5%, preferably 2%, preferably 2.5%, preferably 3%, preferably 3.5%, preferably 4%, preferably 4.5%, preferably 5%, preferably 6%, preferably 7%, preferably 8%.

14. The use according to claim 8, wherein the information about the animal(s) and the animal's feed are the age of the animal(s) [days], Corn protein solubility [mg], Corn vitreousness [%], Corn insoluble A:X ratio, Corn slowly digested starch [g/100 g] and Corn resistant starch [g/100 g].

15. The use according to claim 8, wherein the animal is a mono-gastric animal, e.g. pigs or swine (including, but not limited to, piglets, growing pigs, and sows); poultry (including but not limited to poultry, turkey, duck, quail, guinea fowl, goose, pigeon, squab, chicken, broiler, layer, pullet and chick); pet animals such as cats and dogs, fish (including but not limited to amberjack, arapaima, barb, bass, bluefish, bocachico, bream, bullhead, cachama, carp, catfish, catla, chanos, char, cichlid, cobia, cod, crappie, dorada, drum, eel, goby, goldfish, gourami, grouper, guapote, halibut, java, labeo, lai, loach, mackerel, milkfish, mojarra, mudfish, mullet, paco, pearlspot, pejerrey, perch, pike, pompano, roach, salmon, sampa, sauger, sea bass, seabream, shiner, sleeper, snakehead, snapper, snook, sole, spinefoot, sturgeon, sunfish, sweetfish, tench, terror, tilapia, trout, tuna, turbot, vendace, walleye and whitefish); and crustaceans (including but not limited to shrimps and prawns).
